(19) United States
(12) Patent Application Publication
(10) Pub. No.: US 2016/0291644 A1
(43) Pub. Date: Oct. 6, 2016

(54) BASE DECK WITH CARRIER FEATURES

(71) Applicant: Seagate Technology LLC, Cupertino, CA (US)

(72) Inventor: Steven Lee Weber, Ramsey, MN (US)

(21) Appl. No.: 15/084,752

(22) Filed: Mar. 30, 2016

Related U.S. Application Data
(60) Provisional application No. 62/139,901, filed on Mar. 30, 2015.

(51) Int. Cl. G06F 1/18; B29C 45/14

(52) U.S. Cl. CPC G06F 1/181; B29C 45/14; B29K 2995/0005; B29L 2031/3406

(57) ABSTRACT

A base deck of a storage drive forms a cavity that is designed to contain storage circuitry. The storage drive base deck is designed to mimic features of a storage drive carrier by providing: graspable portions located on a front face of the storage drive base deck; and insertion guide portions located on opposing sides of the storage drive base deck.

### OVERVIEW

Storage drives can be used for data storage in modern electronic products ranging from audio players to computer systems and networks. There are different types of storage drives, including traditional hard disk drives (HDD) that store and retrieve data using one or more rapidly rotating magnetic disks (or platters) as non-volatile memory. Another type of storage drive is a solid-state drive (SSD), which is also known as a solid-state disk. An SSD uses solid-state electronics as non-volatile memory to store data. Moreover, there are solid-state hybrid drives (SSHD) that can use a combination of both SSD and HDD technology.

Storage drives can be designed to meet various physical form factors that facilitate interoperability between storage drives of different manufacturers and within different computer systems. Some computer systems are designed to use storage drive carriers, or caddies, that are attached to the storage drives. The carriers can serve as an interface between the storage drive and the computer system. For example, a storage drive carrier can be designed to allow for simple insertion and removal to a storage drive bay of a computer system. A set of one or more latches can be part of the storage drive carrier that help to secure and remove the storage drive from the bay.

### SUMMARY

Various example embodiments are directed to issues such as those addressed above and/or others which may become apparent from the following disclosure concerning updating of software, and particularly relating to storage drive enclosures with carrier-based features integrated therein.

In certain example embodiments, aspects of the present disclosure relate to a device that includes a base deck of a storage drive, the base deck forming a cavity that is designed to contain storage circuitry, the storage drive base deck designed to mimic features of a storage drive carrier by providing: graspable portions located on a front face of the base deck; and insertion guide portions located on opposing sides of the base deck.

According to various embodiments of the present disclosure, a method is provided for manufacturing a base deck of a storage drive. The method includes forming a base deck that includes a cavity that is designed to contain storage circuitry. The base deck is configured to mimic features of a storage drive carrier by providing: graspable portions located on a front face of the base deck; and insertion guide portions located on opposing sides of the base deck.

The above discussion/summary is not intended to describe each embodiment or every implementation of the present disclosure. The figures and detailed description that follow also exemplify various embodiments

### BRIEF DESCRIPTION OF THE DRAWINGS

Various example embodiments may be more completely understood in consideration of the following detailed description in connection with the accompanying drawings, in which:

FIG. 1 depicts examples of storage drives with carrier-based features, consistent with embodiments of the present disclosure;

FIG. 2 depicts a storage drive with carrier-based features that include movable handles that provide graspable portions, consistent with embodiments of the present disclosure;

FIG. 3 depicts a storage drive with carrier-based features that include graspable portions that protrude from the front of the storage drive, consistent with embodiments of the present disclosure;

FIG. 4 shows a base deck with various optional features, consistent with embodiments of the present disclosure;

FIG. 5 depicts an outline of the dimensions for an assembly of a storage drive and attached caddie relative to the corresponding dimensions of a storage drive designed to emulate the assembly, consistent with embodiments of the present disclosure; and

FIG. 6 depicts a flow diagram for manufacturing a storage drive, consistent with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving a base deck with carrier-based features. In certain implementations, aspects of the present disclosure have been shown to be beneficial when used in the context of a storage drive enclosure with carrier-based features integrated into the base deck of the enclosure. While not necessarily so limited, various aspects may be appreciated through the following discussion of non-limiting examples which use exemplary contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Embodiments of the present disclosure are directed toward a storage drive (or storage drive apparatus) that includes carrier-based features integrated into the storage drive housing in a permanent fashion. The carrier-based features can include a graspable portion and an insertion guide portion. For example, the insertion guide portion can include a set of rails that are designed to guide the storage drive during insertion of the storage drive into a storage drive bay of a larger (server) enclosure. The graspable portion can include grip tabs. As explained in more detail herein, the grip tabs can extend from the storage drive exterior housing using a fixed solution or using an adjustable (e.g., hinged) solution.

According to certain embodiments, carrier-based features can be provided relative to a standard form factor that does not otherwise include the carrier-based features. For example, HDD form factors can include form factors identified as 5.25-inch, 3.5-inch (large form factor), 2.5-inch (small form factor), or 1.8-inch.

Particular embodiments are directed toward a storage drive that includes carrier-based features that emulate one or more storage drive carriers. For instance, the base deck of the storage drive exterior housing can be designed to include the carrier-based features. The storage drive can include the base deck itself being modified to include the carrier-based features. The storage drive can also be configured so that size of the housing is increased to mimic the additional width (relative to the standard storage drive form factors) provided by the addition of the carrier to a storage drive.

Various embodiments are directed toward a storage drive that conforms to a HDD form factors while also including carrier-based features for insertion into and removal from a storage drive bay. In this regard, the size of the slots in the storage bay can be smaller because the slots do not have to account for additional width of a storage carrier on the exterior of a storage device that conforms to the same HDD form factor. Moreover, in some embodiments, the storage drive can still be used either in a storage drive bay or in applications that do not use the carrier-based features (e.g., in a personal desktop computer tower).

In some implementations, one or more plastic portions can be created that are then integrated with the storage drive exterior housing in a (semi) permanent manner. For instance, the plastic portion(s) can be created using an injection mold process, or more particularly, an overmold process. For certain embodiments corresponding to an injection molding solution, the plastic portion can be created separate from the base deck of the storage drive using a mold. During assembly of the storage drive, the plastic portion can be fixed to, and placed over the exterior of, the base deck. For an overmold process, the base deck of the storage drive can be created first and designed to function as a portion of a mold. A complimentary mold portion can be placed over the exterior of the base deck and then used to allow the plastic portion to be molded directly onto the storage drive. The base deck mold portion can be designed so that the plastic portion is fixed to the base deck of the storage drive once the molding process is completed.

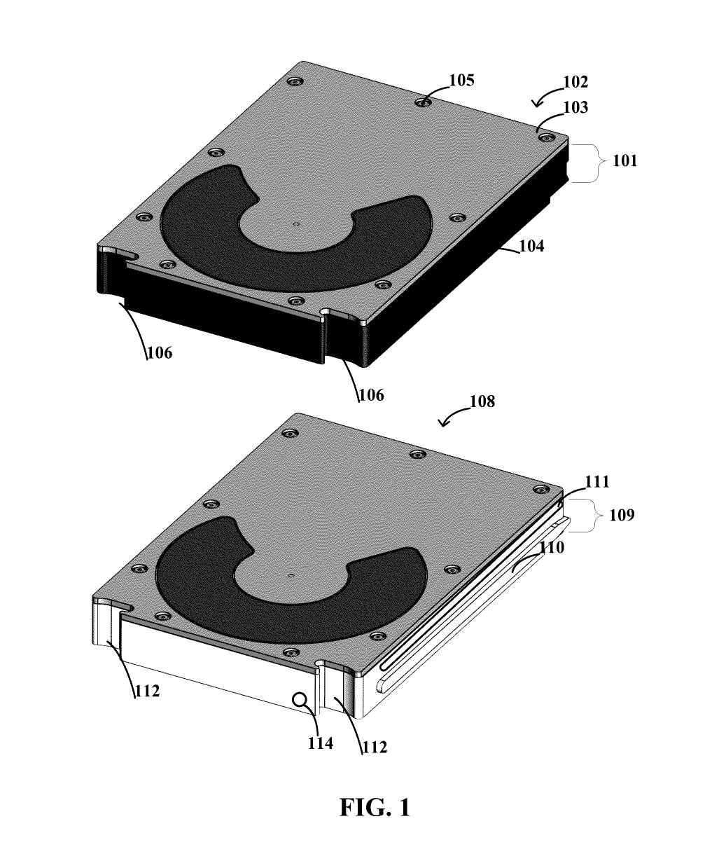

Turning now to the figures, FIG. 1 depicts examples of storage drives with carrier-based features, consistent with embodiments of the present disclosure. Certain embodiments are directed toward a storage drive 102 that has a carrier-based structure that includes insertion guide portions 104 on opposing sides of the base deck. The far (opposing) side of the storage drive 102 is not visible, but can include a mirrored version of the visible guide portion 104. The insertion guide portions 104 can be configured to interface with a computer system housing (e.g., a computer server rack) and to guide the storage drive 102 during insertion. Guide portions 104 are depicted as being recessed into the base deck 101. The recess can be designed to receive a corresponding rail that is part of a storage drive bay of a larger (server) enclosure.

The storage drive 102 can also be configured with graspable portions 106. The graspable portions 106 can be designed to allow a person to exert a removal force on the disc by squeezing with their fingers and pulling. As depicted, the storage drive base deck can be designed with the insertion guide portions 104 and graspable portions 106 integrated directly into a base deck 101. An upper housing (cover) 103 can be affixed to the base deck at attachment points 105 using fasteners (e.g., screws). Although not expressly depicted, some embodiments can use a separate lower housing (floor) that can be attached to the central portion (frame) of the base deck 101 in a similar manner.

Various embodiments are directed toward a storage drive 108 that has insertion guide portions 110 (far side not visible) that protrude from the side of the base deck 109. Graspable portions 112 can also be provided with the guide portions 110 by way of a plastic piece that is integrated into the base deck 109 of the storage drive 108. As discussed herein, the plastic piece can be attached using an overmold process in which the base deck includes a recessed portion that functions as part of the mold for the overmold process. This recessed portion of the base deck is not visible in FIG. 1 because the overmold portion has already been created by filling the recessed portion.

According to embodiments, the insertion guide portions can be designed to operate as a tongue-and-groove sliding solution in which the insertion portion can function as either the groove (indentation or recession), per portion 104, or the tongue (protrusion), per portion 110. The storage drive bay of the larger enclosure can be designed to function as the other of the tongue and groove.

In certain embodiments, multiple grooves or tongues can be included as part of the insertion guide. When used with computer system housings that are also designed to use multiple guides, this can be useful for improving the robustness of the design (e.g., good stability and strength of interface). In some instances, the multiple grooves or tongues are located at different vertical heights on the side of the base deck (e.g., at location 111). The different heights can each be designed for different computer systems, which can have a corresponding tongue or groove at one of the different heights. Moreover, a combination of grooves and tongues can be useful for allowing the use of the same storage device with different storage drive bays and corresponding configurations.

According to embodiments, variations in insertion guide structures between different storage drive bays can be accommodated using multiple overmolding designs that can each be permanently attached to the same storage drive. For example, the base deck of the storage drive can be configured to provide a portion of a mold for an overmolding process. There can be multiple versions of the other portion of the mold, each of which can be configured with different features (e.g., different size and locations for the insertion guide portions), which can be useful for providing compatibility with different storage drive bay configurations. The same underlying base deck can then be used for multiple different solutions by simply selecting a different external mold during the manufacturing process.

In certain embodiments, the insertion guide can have a varying thickness/width to facilitate mating with the housing of the storage bay. For example, the groove can be widened at the back of the housing or, alternatively, a tongue can be narrowed at the back of the housing. This can facilitate the initial mating between the insertion guide portions and the computer system housing by increasing the tolerance between the mated pair as during the initial interfacing process.

According to certain embodiments, the insertion guide portions can include a conductive element that is configured to provide a ground path between electrical components of the storage drive and the computer system, as may be useful for providing electrostatic discharge (ESD) protection. This can be accomplished using, for example, a conductive material for the (entire) insertion guide, or by integrating electrical contacts at one or more points along the insertion guide. A (ESD) protection circuit of the storage drive can be connected to the conductive material or contacts using wiring, the base deck itself, or combinations thereof. According to certain embodiments, the overmold process can use an electrically conductive elastomer material. In some embodiments, the mold can include inserts or recesses for including electrical (e.g., metal) contacts and connections (e.g., wiring).

In various embodiments, storage drive or system status display elements can be included as part of the carrier-based structure. This can include, for example, one or more light-emitting-diodes (LEDs) that are connected to the computer system to provide status information (e.g., power, activity, or the like). In certain embodiments, the LEDs can be connected to the computer system through wiring that is contained with the carrier-based structure (e.g., wiring that is included during the overmolding process). For example, the base deck 101, 109 can include a recess that forms part of the mold. The recess can include space for the placement of wires. The wires can be placed within the recess before the overmolding process is carried out. In some instances, the base deck 101, 109 can include one or more support structures that are designed to hold the electrical wires. For example, the wiring can be placed in small U-shaped clip structures that hold the wiring until the overmold process encapsulates the wires.

In some embodiments, the LEDs can be connected through electrical circuitry of the storage drive. For instance, some storage drives use a printed circuit board (PCB) that is located on the floor (bottom) of the base deck and that extends a significant distance from the back to the front of the storage drive. The PCB can be configured to route signals from the computer system to the LEDs (e.g., with additional connectors on the front and back side of the PCB for connecting with the LEDs and computer system, respectively). In certain implementations, the overmolded portion can be configured to include openings in the front of the base deck to accommodate one or more LEDs (e.g., at or near location 114).

Certain embodiments allow for the inclusion of physical shock dampening or absorption components. For instance, rubber or similar material can be affixed to the insertion guide using an adhesive. In some embodiments, the entire overmold portion, including the insertion guide, can be constructed from a material that has shock dampening properties.

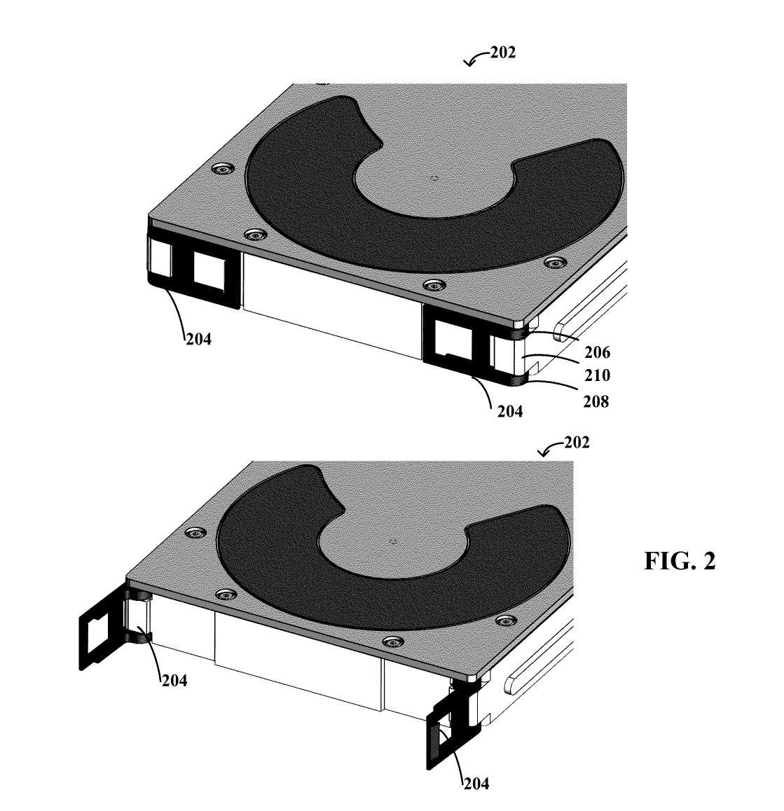

FIG. 2 depicts a storage drive with carrier-based features that include movable handles that provide graspable portions, consistent with embodiments of the present disclosure. Storage drive 202 is depicted with graspable portions 204 that are hinged to allow the graspable portions to be extended (204 as extended in the lower view) when in use and folded down (204 as collapsed in the upper view) when not in use. The hinge solution can be either directly integrated as part of the base deck (e.g., as discussed in connection with storage drive 102), or with an overmolded piece that overlays a portion of the base deck (e.g., as discussed in connection with storage drive 108). In either case, the hinge action can be created by placing the portions 206 and 208 of the handle on either side of extension piece 210 of the base deck. A pin can then be inserted through a hole in the portions 206 and 208 and the extension piece 210, and the resulting hinge can allow the graspable portion 204 to rotate about the pin.

According to various embodiments, a number of different handles can be designed for use with the same base deck and extension piece 210. For instance, the handles can have varying lengths, different thicknesses, and different sizes. An appropriate handle can be selected depending upon the specific application (e.g., depending upon the design of the particular storage drive bay being used). For example, certain storage drive bays may have impediments that make it difficult to grab the graspable portions 204, and longer graspable portions 204 may allow an individual more room to grasp the handles.

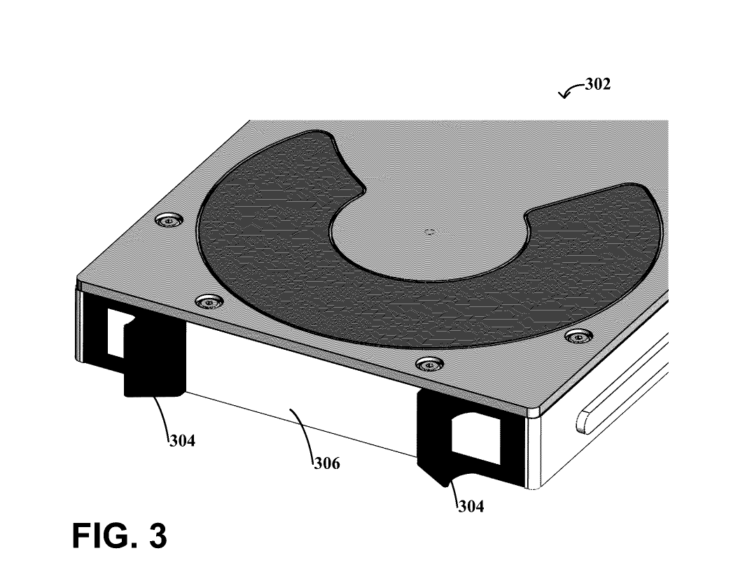

FIG. 3 depicts a storage drive with carrier-based features that include graspable portions that protrude from the front of the storage drive, consistent with embodiments of the present disclosure. Storage drive 302 is depicted with graspable portions 304 that protrude from the front portion of the storage drive base deck. The graspable portions 304 extend from a relatively flat front face 306 of the storage drive. Relative to the front face, this represents a protrusion (as opposed to an indentation for the graspable portions 106 as shown in FIG. 1).

In some embodiments, graspable portions 304 can be created during the same overmold process that is used to create the guide portions and front face 306. Different shapes and sizes for the graspable portions 304 can be achieved be selecting different molds. In some implementations, the graspable portions 304 can be separate pieces that are attached to the base deck. For example, the base deck and graspable portions 304 can be configured with fastening solutions that include, but are not necessarily limited to, one or more of a snap-in fastening solution, adhesives, and screws.

FIGS. 1-3 show two graspable portions equally spaced on the outside of the front face of the respective base decks. Various embodiments are directed toward the use of a single graspable portion that is located on either side or in the middle of the front face.

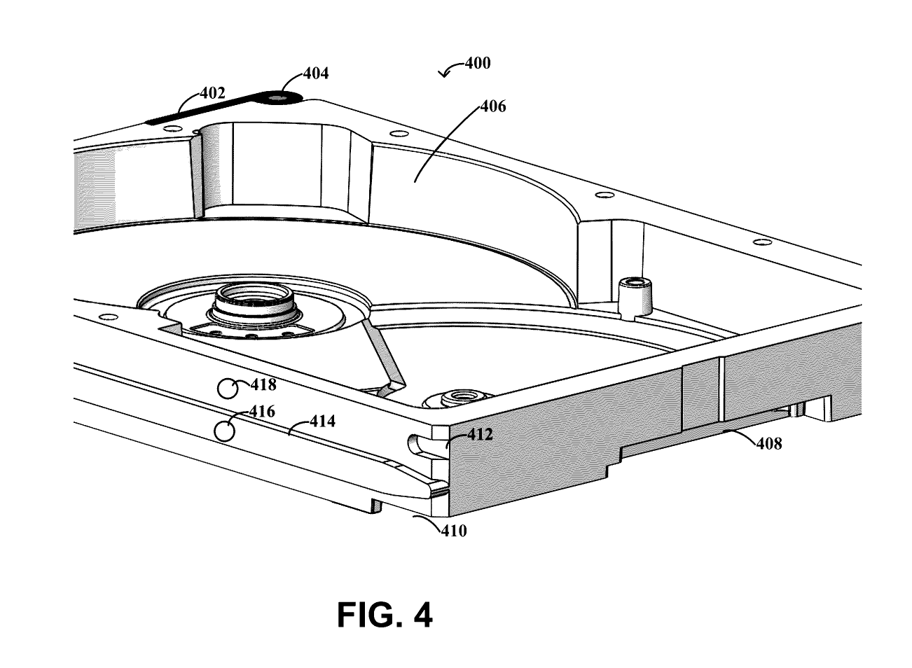

FIG. 4 shows a base deck with various optional features, consistent with embodiments of the present disclosure. Base deck 400 includes a cavity 406. The depicted cavity 406 is generally consistent with a HDD as it includes a circular area that can house the magnetic platters, as well as additional space for other HDD components. It is noted that different shapes and configurations for the cavity 406 are possible.

According to various embodiments, the base deck can include one or more graspable portions 402 that are attached to the base deck using a hinge that allows the graspable portions 402 to rotate. As discussed herein, the hinge can be formed about a pin 404, or similar cylindrical structure, such that the graspable portions 402 can rotate away from the front face of the base deck and be more easily grasped by a person during removal of the storage drive. The base deck 400 can also include one or more openings 408 that allow access to a connector that is part of the internal components of the storage drive.

Consistent with some embodiments of the present disclosure, the base deck can include one or more stops 412, which can correspond to another carrier-based feature. The stops 412 can be designed to interface with the back portion of a storage bay and to prevent the storage drive from being inserted any further into the storage bay. This can ensure that the storage drive is inserted to the proper depth within the storage bay. The proper depth can be important for preventing damage to the storage bay or storage drive, leaving sufficient space for servicing a rear connector that is accessible through opening 408, maintaining sufficient air flow, and keeping the front face of the storage device aligned with the front of the storage bay so that the graspable portions 402 are easily accessible. In addition to providing depth alignment, the stops 412 can provide additional mechanical support for the storage device.

Various embodiments are directed toward the use of a recessed section 410. This section can allow a portion of the storage drive to slide over a support in the back of the storage bay. The stop can prevent the support from hitting the end of the recessed section 410. The support can provide additional stability by allowing the back of the storage drive to rest upon the support.

In certain embodiments of the present disclosure, the base deck includes one or more attachment points 416 and 418. For example, the attachment points 416 and 418 can be screw holes that correspond to a HDD form factor. For embodiments in which the storage device dimensions are consistent with the HDD form factor (e.g., as opposed to adding additional width and length), the screw holes allow the storage device to be used in either a storage bay that uses guides 414, or a desktop (or similar) computer designed for use with the HDD form factor.

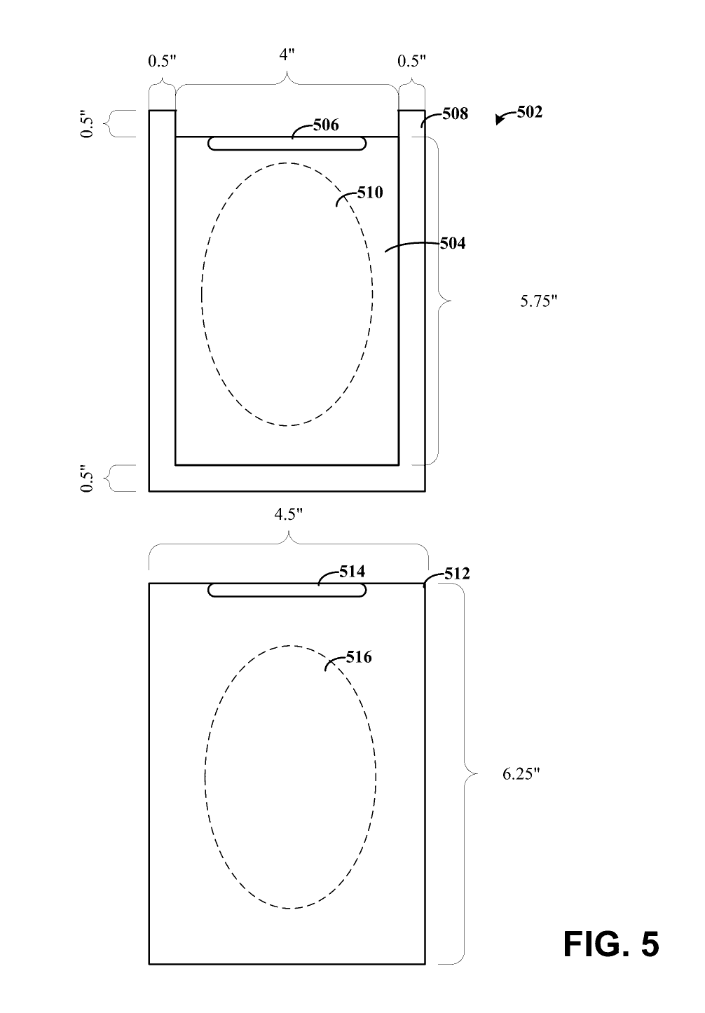

FIG. 5 depicts an outline of the dimensions for an assembly of a storage drive and attached caddie relative to the corresponding dimensions of a storage drive designed to emulate the assembly, consistent with embodiments of the present disclosure. Assembly 502 can include a storage drive 504 that has been placed within a storage drive carrier, or caddy, 508. The dimensions of the storage drive 504 are 4″ by 5.75″, which corresponds to the 3.5-inch (large form factor) hard disk drive standard. The specific dimensions can vary according to the application (e.g., including the 2.5-inch (small form factor)). Storage drive carrier 508 is depicted as adding an additional 0.5″ to each of the outside of the front, sides, and back of the storage drive 504. Area 510 represents a cavity formed within the base deck and designed to hold memory circuitry and related components. For example, for a hard disk drive (HDD), the cavity 510 can be designed to hold mechanical components or parts (including the rotating magnetic platters) of the HDD as well as the associated control circuitry, power circuitry, and memory cache circuitry. For a solid-state drive (SDD), the cavity 510 can be designed to hold memory circuits (e.g., flash memory circuit), control circuitry, power circuitry, and memory cache circuitry.

Connector 506 can include various types of electrical connects that can be used to provide power and to communicate both data signals and control signals between the storage drive 504 and an external device. The connector 506 can be designed for compatibility with various bus interfaces and connectors such as, serial advanced technology attachment (SATA), SATA II, SATA III, SATA Express, peripheral component interconnect (PCI), PCI eXtended, PCI Express, Non-Volatile Memory Express (NVMe), M.2, and U.2.

Storage drive 512 is designed to include similar carrier-based features as the assembly 502, with these carrier features being integrated into, and permanent part of, the base deck. The outer dimensions are shown as being 4.5″ by 6.25″, which corresponds to the outer dimensions of the assembly 502. Thus, the housing of the storage drive 512 emulates the caddy portion 508 so that the storage drive 512 can be used in the same storage drive bay as the assembly 502, but without a separate caddy.

Consistent with certain embodiments of the present disclosure, the connector 514 and cavity 516 can have the same shape and orientation as the connector 506 and cavity 510. The use of the same shape and orientation can allow for the use of the same internal components for each of the storage drives 504 and 512.

In certain implementations, the base deck of the storage drive 504 can be configured to support an overmold that results in the outline shown in storage drive 512. In other words, the additional width and height of storage drive 512 can be produced by applying an overmold to the base deck of the storage drive 504. This can be particularly useful for allowing the use of a common base deck for each of the storage drives 504 and 512, which may help reduce manufacturing costs.

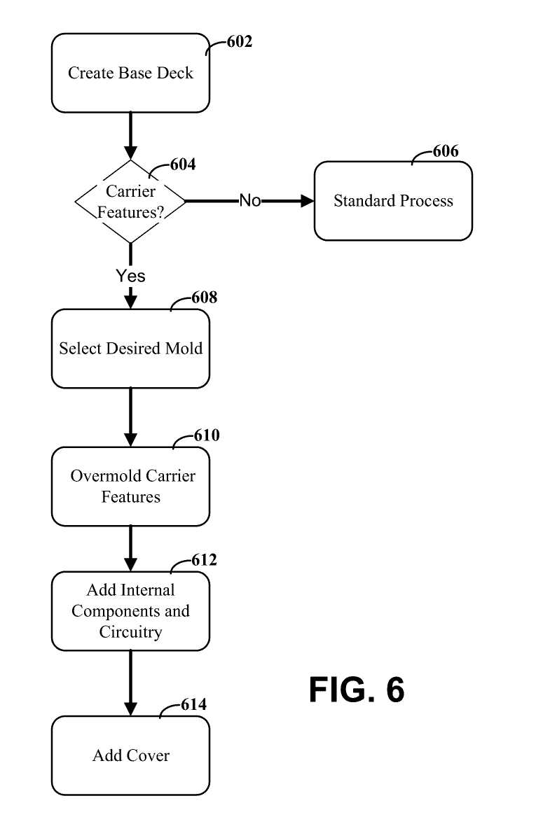

FIG. 6 depicts a flow diagram for manufacturing a storage drive, consistent with embodiments of the present disclosure. The flow begins with the creation of a base deck for a storage device, per block 602. As discussed herein, the base deck can be designed for use with an overmold process in which the base deck forms part of the mold.

In some embodiments, the base deck can be constructed such that, without the overmold process, the base deck can be used in a storage device that has a housing that conforms to a HDD form factor. For example, the base deck could be designed consistent with the HDD 3.5-inch (large form factor). The same base deck can then be used to create a storage device housing that conforms with the large form factor or a housing that is designed to emulate an additional carrier added to a large form factor housing (for use in a storage bay). In such embodiments, the manufacturing process can include determining whether or not carrier features are to be emulated, per block 604. If not, then the standard process for the large form factor housing can be used, per block 606.

If carrier features are to be included, the overmold (or similar process) can then be carried out. In some embodiments, the base deck can be designed for use with multiple different molds, each of which might be designed for use with a different type of storage bay. The desired mold can therefore be selected at this stage, as depicted by block 608. In some instances, wiring might be placed within the mold area at this point as well. The overmold process is then implemented to create the carrier features, per block 610.

The internal memory components and circuits can then be placed within the cavity of the base deck, per block 612. Further elements can also be added at this point, such as the placement of LEDs into the base deck. The cover can then be added to enclose the internal memory components within the housing, per block 614.

FIGS. 2-4 are drawn to scale and can be used for determining relative locations and sizes of depicted components. In some instances, the relative sizes have relevance to the function and use of the components. For example, the placement and size of the depicted guide portions shows a particular example that can provide relatively good stability and ease of installation and removal relative to a storage bay. Similarly, the size and orientation of the graspable portions are representative of a useful size and configuration thereof. Notwithstanding, the disclosed embodiments are not necessarily limited to a specific size or orientation of any individual component or combination of components.

Terms to exemplify orientation, such as upper/lower, left/right, top/bottom and above/below, may be used herein to refer to relative positions of elements as shown in the figures. It should be understood that the terminology is sometimes used for notational convenience and with respect to specific embodiments. In actual use, the disclosed structures may be oriented differently than the orientation shown in the figures, and the terms should not be construed in a limiting manner.

For the purposes of this document, the following terms and definitions apply: a) storage drive: a memory storage device that includes memory circuitry within a self-contained housing, with particular examples including HDDs, SSDs and SSHDs, b) solid-state electronics: electric components that are based in semiconductor technology, with particular example being flash memory circuits (as opposed to magnetic disk technology); c) base deck: a mechanical structure that forms an enclosure when attached to a corresponding cover; and d) overmold process: a process of molding an additional layer of material (e.g., plastic) over an existing component, where the existing component can serve as a part of the mold.

According to embodiments, circuits or circuitry are used together with other elements to carry various steps, functions, operations, activities, etc. For example, in certain of the above-discussed embodiments, a computer system, discrete logic circuits, and/or programmable logic circuits can be configured and arranged for implementing a manufacturing process, as may be carried out in the approaches shown in FIG. 6. In certain embodiments, the computer system can include a processor circuit and a memory circuitry. The memory circuitry can store a set of instructions that can be executed to carry out the algorithms and processes, as described in connection with the corresponding embodiments.

Accordingly, based upon the above discussion and illustrations, those skilled in the art will readily recognize that various modifications and changes may be made to the present disclosure without strictly following the exemplary embodiments and applications illustrated and described herein. For example, graspable portions can be adjusted using connections other than hinges. Such modifications do not depart from the true spirit and scope of the present disclosure, including that set forth in the following claims.

What is claimed is:

1. A device comprising:
a base deck of a storage drive, the base deck forming a cavity that is designed to contain storage circuitry, the storage drive base deck designed to mimic features of a storage drive carrier by providing:
graspable portions located on a front face of the base deck; and
insertion guide portions located on opposing sides of the base deck.

2. The device of claim 1, wherein the guide portions include a tongue designed to fit in a groove that is part of a tongue-and-groove sliding solution.

3. The device of claim 1, wherein one of the features that is mimicked is a width of the base deck that corresponds to the attachment of the storage drive carrier to another storage drive having a particular storage drive form factor.

4. The device of claim 3, wherein the particular storage drive form factor is a hard disk drive (HDD) 3.5″ form factor.

5. The device of claim 1, wherein the cavity is further configured to contain mechanical components of a hard disk drive, including one or more magnetic platters.

6. The device of claim 1, wherein the cavity is configured to contain solid-state memory circuitry and control circuitry.

7. The device of claim 1, wherein the storage drive base deck is further designed to mimic features of the storage drive carrier by providing stops at the rear of the base deck.

8. The device of claim 1, further comprising a cover that forms an enclosure around the cavity by attaching to the base deck.

9. The device of claim 1, wherein the insertion guide portions protrude from the opposing sides of the base deck.

10. The device of claim 1, wherein the insertion guide portions are recessed into the opposing sides of the base deck.

11. The device of claim 1, wherein the insertion guide portions extend from the front to back of the base deck and along each opposing side.

12. The device of claim 11, wherein the insertion guide portions include two or more portions on each opposing side and arranged at different vertical heights on the base deck.

13. The device of claim 1, wherein the graspable portions include a hinge that allows the graspable portions to rotate away from the front face of the base deck.

14. The device of claim 13, wherein the hinge includes a pin that attaches the graspable portions to the front face of the base deck.

15. A method for manufacturing a base deck of a storage drive, the method comprising:
forming a base deck that includes a cavity that is designed to contain storage circuitry;
configuring the base deck to mimic features of a storage drive carrier by providing:
graspable portions located on a front face of the base deck; and
insertion guide portions located on opposing sides of the base deck.

16. The method of claim 15, wherein the configuring the base deck to mimic features of a storage drive carrier includes creating the graspable portions and insertion guide portions using an overmold process.

17. The method of claim 16, wherein the overmold process includes selecting a mold from a plurality of different molds based upon a particular configuration of a storage drive bay, and using the selected mold during the overmold process.
